(19) United States
(12) Patent Application Publication
(10) Pub. No.: US 2010/0095778 A1
(43) Pub. Date: Apr. 22, 2010

(54) PRESURE SENSOR AND PRESSURE RECEIVER

(75) Inventor: Kenta SATO, Chigasaki (JP)

Correspondence Address: HARNESS, DICKEY & PIERCE, P.L.C., P.O. BOX 828, BLOOMFIELD HILLS, MI, 48303, US

(73) Assignee: EPSON TOYOCOM CORPORATION, Tokyo (JP)

(21) Appl. No.: 12/577,265

(22) Filed: Oct. 12, 2009

(30) Foreign Application Priority Data
Oct. 16, 2008 (JP) 2008-267501
Jul. 30, 2009 (JP) 2009-177797

(51) Int. Cl. G01L 9/00

(52) U.S. Cl. 73/756; 73/723

(57) ABSTRACT

A pressure sensor includes a pressure sensing element and a pressure receiver. The pressure sensing element includes a pressure sensing portion and a pair of base portions connected to both ends of the pressure sensing portion. The pressure receiver has a first main surface that is a pressure receiving surface and a second main surface that is a back side of the pressure receiving surface. The pressure receiver includes a pair of supporting portions provided on the second main surface. The pair of supporting portions cover one main surface of the pressure sensing element and support the pair of base portions of the pressure sensing element. The pressure receiver has a thick portion in a position symmetrical with respect to at least one of a first virtual line passing through a center of the second main surface and extending in a direction of an arrangement of the pair of supporting portions and a second virtual line passing through the center and extending in a direction perpendicular to the first virtual line.

### BACKGROUND

1. Technical Field

The present invention relates to a pressure sensor using a piezoelectric element as a pressure detecting element, and a pressure receiver.

2. Related Art

JP-A-2004-132913 and JP-A-2007-327992 each discloses a pressure sensor including a diaphragm serving as a pressure receiver including a deformable portion that receives pressure to be measured and thus becomes deformed, and a doubled-ended tuning fork-type resonator element serving as a pressure sensing element supported by and fixed to a supporting portion of the diaphragm.

For the pressure sensor disclosed in JP-A-2004-132913, when the diaphragm receives pressure and thus becomes deformed, force caused by the deformation is transmitted to the doubled-ended tuning fork-type resonator via the supporting portion. As a result, the doubled-ended tuning fork-type resonator also becomes deformed and thus expands or contracts in the direction of a resonating arm (beam) thereof. Due to internal stress caused by the expansion or contraction, the resonant frequency of the doubled-ended tuning fork-type resonator varies. The resonant frequency variation is converted into a pressure variation. In this way, the pressure variation is detected.

The above-mentioned pressure sensing element includes a pressure sensing portion and a pair of base portions connected to both ends of the pressure sensing portion. In the piezoelectric resonator element, the direction of detecting force is set as the detection axis, and the direction of arrangement of the pair of base portions of the pressure sensing element is in parallel with the detection axis. In the doubled-ended tuning fork-type resonator, the direction of extension of the beam is in parallel with the detection axis.

However, there is a problem that when the diaphragm becomes deformed significantly, the central portion of the diaphragm deformed in the shape of an arc makes contact with the doubled-ended tuning fork-type resonator element and thus this causes the diaphragm and resonator to be damaged.

In order to solve this problem, JP-A-2007-327992 proposes, as shown in FIG. 9, that a thick portion 2 is provided in the central area of a diaphragm 1 so that the central area of the diaphragm 1 does not become deformed in the shape of an arc even if the diaphragm 1 becomes deformed significantly. This can prevent a central portion 3 of the diaphragm 1 from making contact with a doubled-ended tuning fork-type resonator element 4.

Assuming that the thickness of the diaphragm is uniform as in JP-A-2004-132913, when vibration of the doubled-ended tuning fork-type resonator element is transmitted to the diaphragm via a supporting portion, the diaphragm itself starts to vibrate, and the natural frequency of the diaphragm is coupled to the resonant frequency of the doubled-ended tuning fork-type resonator. In this case, there is a problem that when the resonant frequency of natural vibration of the diaphragm is close to the resonant frequency of the doubled-ended tuning fork-type resonator, the resonant frequency of the diaphragm appears as spurious or unwanted mode near the resonant frequency of the double-ended tuning fork-type resonator, and thus there occur variations in the frequency of oscillation of an oscillation circuit to which the double-ended tuning fork-type resonator is electrically connected.

The vibration state of the doubled-ended tuning fork-type resonator can be represented by a CI value. FIG. 10(1) is a graph showing the relation between the CI value and pressure. FIG. 10(2) is a drawing schematically showing the vibration state of a plane of the diaphragm. As shown in FIG. 10(1), there are locations (point A, etc.) where when pressure (kPa) is changed, the CI (k-ohm) varies under particular pressure. In the locations (singular CI value points, that is, locations where Dip is occurring) where the CI value varies, the diaphragm vibrates significantly.

FIG. 10(2) shows the vibration state of the rectangular diaphragm at the point A where Dip occurs and that is placed under a pressure of 30 kPa and that at a point B where no Dip occurs and that is placed under a pressure of 100 kPa. For the point A with Dip, it was observed that the central portion of the diaphragm vibrated significantly; for the point B with no Dip, it was observed that the central portion of the diaphragm vibrated less significantly.

As is understood from the above-mentioned verification result, when pressure varies in a pressure measurement environment, a shift in the resonant frequency of the doubled-ended tuning fork-type resonator element due to the pressure variation does not occur under pressure with no Dip, as shown in FIG. 11(1). However, it is supposed that, under pressure with Dip as shown in FIG. 11(2), the frequency shifts or varies when the resonant frequency of the doubled-ended tuning fork-type resonator element comes closer to the frequency of the diaphragm.

If a vibrating string of a stringed instrument is pressed by a finger, the vibration is restrained. Similarly, if a thick portion is provided on the central portion in order to prevent the central portion from becoming deformed when the deformable portion becomes deformed, as disclosed in JP-A-2007-327992, it is expected to obtain an effect of restraining resonance of the diaphragm.

In order to dispose a thick portion on the diaphragm so as to restrain vibration of the diaphragm, the inventor performed a simulation about the correlation between the sensitivity of the deformable portion of the diaphragm and the disposition location of the thick portion. As a result, there was found a problem that the deformation sensitivity of the deformable portion was lost significantly in the configuration where a thick portion is disposed in the central portion of the diaphragm as shown in JP-A-2007-327992.

### SUMMARY

An advantage of the invention is to provide a pressure sensor and a pressure receiver that restrain vibration of a diaphragm without deteriorating the deformation sensitivity of a deformable portion.

A pressure sensor according to a first aspect of the invention includes a pressure sensing element and a pressure receiver. The pressure sensing element includes a pressure sensing portion and a pair of base portions connected to both ends of the pressure sensing portion. The pressure receiver has a first main surface that is a pressure receiving surface and a second main surface that is a back side of the pressure receiving surface. The pressure receiver includes a pair of supporting portions provided on the second main surface. The pair of supporting portions cover one main surface of the pressure sensing element and support the pair of base portions of the pressure sensing element. The pressure receiver has a thick portion in a position symmetrical with respect to at least one of a first virtual line passing through a center of the second main surface and extending in a direction of an arrangement of the pair of supporting portions and a second virtual line passing through the center and extending in a direction perpendicular to the first virtual line.

Thus, the thick portion having an effect of restraining vibration of the pressure receiver is formed in a position symmetrical with respect to at least one of the first virtual line passing through the center of the second main surface and extending in the direction of the arrangement of the pair of supporting portions and the second virtual line passing through the center and extending in a direction perpendicular to the first virtual line. This restrains Dip, as well as prevents deterioration of the deformation sensitivity of the pressure receiver.

In the pressure sensor according to the first aspect of the invention, the thick portion is preferably formed on and integrated with at least one of the first main surface and the second main surface of the pressure receiver.

Thus, the thick portion can be formed in the pressure receiver manufacturing process. Therefore, the thick portion manufacturing process can be omitted.

In the pressure sensor according to the first aspect of the invention, the thick portion is preferably formed and bonded on at least one of the first main surface and the second main surface of the pressure receiver.

Thus, the thickness of the thick portion can be adjusted regardless of what is the thickness of the pressure receiver. Also, after manufacturing the pressure receiver, the thick portion can be formed in a downstream process.

A pressure receiver according to a second aspect of the invention includes: a first main surface that is a pressure receiving surface; a second main surface that is a back side of the pressure receiving surface; and a pair of supporting portions provided on the second main surface. The pair of supporting portions support a pair of base portions connected to both ends of a pressure sensing element. The pressure receiver has a thick portion in a position symmetrical with respect to at least one of a first virtual line passing through a center of the second main surface and extending in a direction of an arrangement of the pair of supporting portions and a second virtual line passing through the center and extending in a direction perpendicular to the first virtual line.

Thus, the thick portion having an effect of restraining vibration of the pressure receiver is formed in a position symmetrical with respect to at least one of the first virtual line passing through the center of the second main surface and extending in the direction of the arrangement of the pair of supporting portions and the second virtual line passing through the center and extending in a direction perpendicular to the first virtual line. This restrains Dip, as well as prevents deterioration of the deformation sensitivity of the pressure receiver.

### BRIEF DESCRIPTION OF THE DRAWINGS

The invention will be described with reference to the accompanying drawings, wherein like reference numerals represent like elements.

FIG. 1 is an exploded perspective view of a pressure sensor according to an embodiment of the invention.

FIG. 2 is a sectional view of the pressure sensor.

FIG. 3 is a plan view of a pressure receiver according to this embodiment.

FIGS. 4(1) and 4(2) are drawings showing the curvature of a diaphragm.

FIGS. 5(1) and 5(2) are drawings showing curvature differentiation of the diaphragm.

FIGS. 6(1) to 6(5) are plan views showing a modification of thick portions of the diaphragm for use in the pressure sensor.

FIGS. 7(1) to 7(6) are drawings showing a thick portion.

FIGS. 8A to 8C are partial enlarged sectional views of a thick portion.

FIGS. 9A and 9B are drawings showing a schematic configuration of a related-art pressure sensor.

FIGS. 10(1) and 10(2) are drawings showing the relation between the CI value and pressure.

FIGS. 11(1) and 11(2) are graphs showing the relation between the vibration intensity and the frequency.

### DESCRIPTION OF EXEMPLARY EMBODIMENT

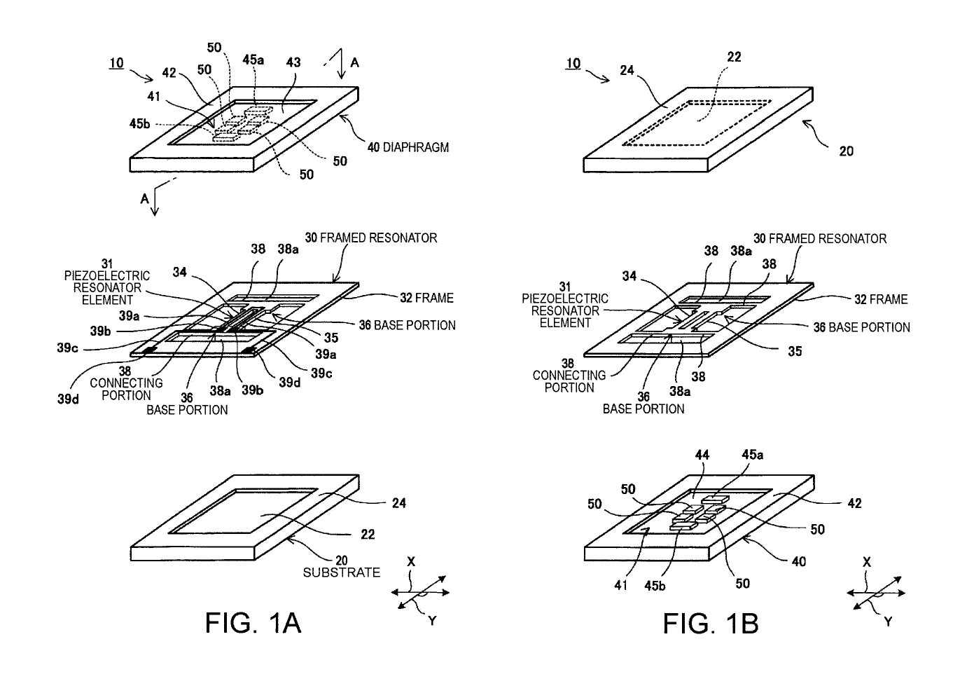

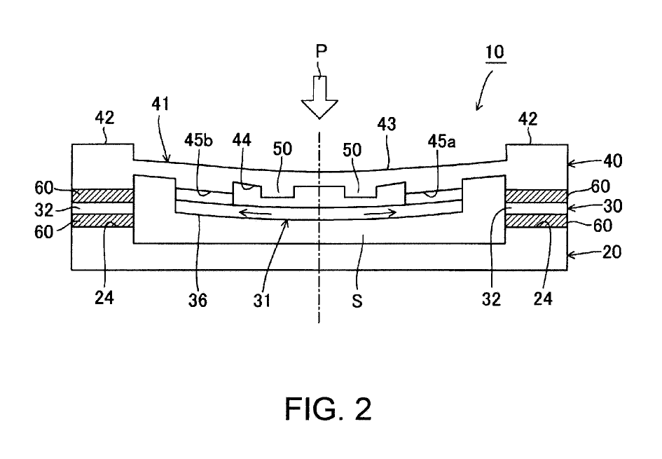

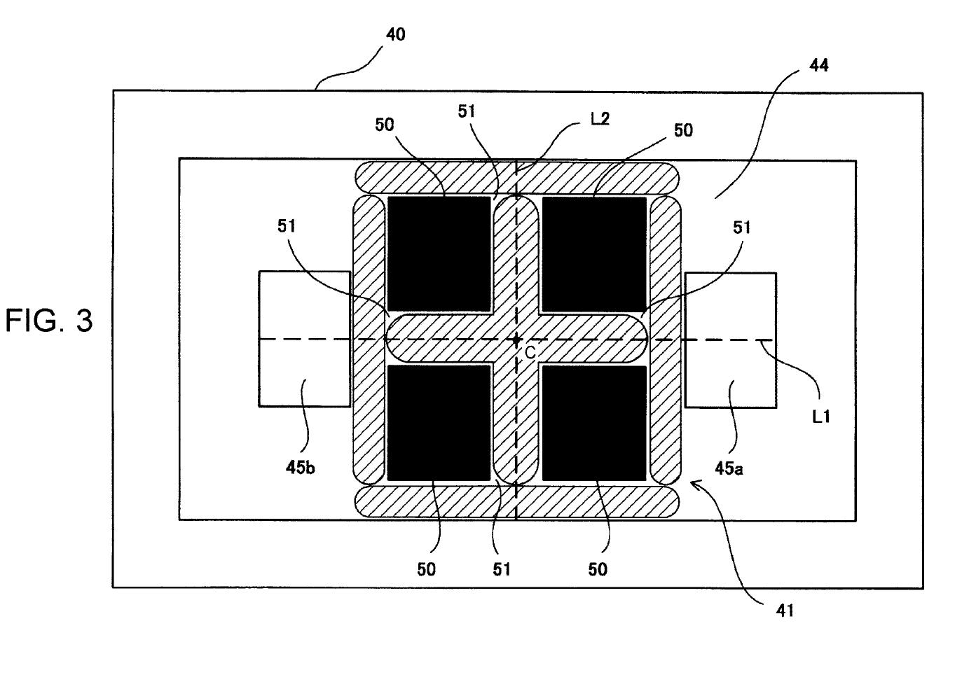

A pressure sensor and a pressure receiver according to an embodiment of the invention will be described in detail with reference to the accompanying drawings. FIGS. 1A and 1B are exploded perspective views of the pressure sensor according to this embodiment. FIG. 1A is a perspective view of the interior (recessed portion) of a substrate seen from above. FIG. 1B is a perspective view of the interior (supporting portion) of a diaphragm seen from above. FIG. 2 is a sectional view of the pressure sensor. FIG. 3 is a plan view of the pressure receiver. As shown in the drawings, a pressure sensor 10 according to this embodiment includes a substrate 20, a framed resonator 30, and a diaphragm (pressure receiver) 40.

As shown in FIG. 1, a first main surface of the diaphragm 40 serves as a pressure receiving surface 43 that receives pressure to be measured. The diaphragm 40 includes a deformable portion 41 that becomes deformed when the pressure receiving surface 43 receives the pressure to be measured from a direction perpendicular to the pressure receiving surface, and a frame 42 formed on the perimeter of the deformable portion 41. A pair of supporting portions 45a and 45b for fixing a piezoelectric resonator element 31 serving as a pressure sensing element are provided on a sealed main surface 44 that is a second main surface of the diaphragm 40 and is the back side of the pressure receiving surface 43 of the deformable portion 41. A pair of base portions 36 of the piezoelectric resonator element 31 are supported by the supporting portions 45a and 45b.

As the pressure sensing element, a so-called “doubled-ended tuning fork-type resonator” is used. The doubled-ended tuning fork-type resonator has base portions 36 at both ends thereof. Two resonating beams are formed on a resonating portion serving as a pressure sensing portion between the two base portions 36. The resonating beams extend from one of the base portions 36 to the other. A characteristic of the doubled-ended tuning fork-type resonator is that when tensile stress (extensional stress) or compressive stress is applied to the two resonating beams serving as the pressure sensing portion (resonating arms 34 and 35), the resonant frequency of the doubled-ended tuning fork-type resonator varies approximately in proportion to the applied stress.

The piezoelectric resonator element 31 includes the pressure sensing portion and the pair of base portions 36 formed at the ends of the pressure sensing portion. In the piezoelectric resonator element 31, the direction of detection of force is set as the detection axis. The direction of arrangement of the pair of base portions 36 of the piezoelectric resonator element 31 is in parallel with the detection axis. For the doubled-ended tuning fork-type resonator, the direction of extension of the beams is in parallel with the detection axis.

The substrate 20 is a member serving as a package or lid for sealing internal space S into which the piezoelectric resonator element 31 of the framed resonator 30 is put. As shown in FIGS. 1A and 1B and 2, the substrate 20 has a recess 22 thereon. By sequentially bonding a frame 32 of the framed resonator 30 and a peripheral portion 42 of the diaphragm 40 to an end surface 24 serving as an annular circumferential portion on the perimeter of the recess 22, the interior of the recess 22 becomes the sealed internal space S.

The above-mentioned substrate 20 may be made of a non-conductive material, such as a ceramic plate or a hard plastic. For example, if ceramic is used, a ceramic green sheet made of aluminum oxide may be formed in the shape shown in the drawings. In this embodiment, the substrate 20 is made of a material similar to that of the frame 32 surrounding the piezoelectric resonator element 31, such as quartz crystal, in consideration of the thermal expansion coefficient or the like.

The external shape of the main surface of the substrate 20 shown in FIGS. 1A and 1B is a rough rectangle formed by two sides extending in parallel with the x axis direction of a quartz crystal axis and two sides extending in parallel with the y axis direction of the quartz crystal axis.

An electrode terminal (not shown) is provided on an exposed surface of the substrate 20. This electrode terminal receives or outputs signals from or to the piezoelectric resonator element 31 via a conductive pattern (not shown).

The framed resonator 30 includes the frame 32 and piezoelectric resonator element 31 connected to the frame 32. The framed resonator 30 is formed by etching a piezoelectric material, such as quartz crystal. Instead of quartz crystal, lithium tantalate, lithium niobate, or the like may be used. The external shape of the frame 32 shown in FIGS. 1A and 1B is a rough rectangle formed by two sides extending in parallel with the x axis direction and two sides extending in the y axis direction.

In this embodiment, as the piezoelectric resonator element 31, a doubled-ended tuning fork-type resonator element whose frequency significantly varies when force is applied thereto and that can detect pressure with high sensitivity is used. Specifically, the doubled-ended tuning fork-type resonator element is a resonator element having flexural vibration mode and has a structure where end surfaces adjacent to a free end, of two tuning fork-type resonator elements are opposed and bonded to each other, as shown in FIGS. 1A and 1B. The doubled-ended tuning fork-type resonator element includes the two resonating arms 34 and 35 whose length directions extend in parallel with each other in the y axis direction, and the two base portions 36 that are connected to both ends in the length direction, of the resonating arms 34 and 35 and arranged in line with the resonating arms 34 and 35.

The resonating arms 34 and 35 are portions that are elongated in the y axis direction and flexurally vibrate when subjected to application of a drive voltage by excitation electrodes 39a provided on surfaces of the resonating arms 34 and 35. When these portions are subjected to application of stress or tension so that the portions expand and/or contract in the y axis direction, the frequency varies. Therefore, by detecting the frequency variation, a variation in pressure can be sensed.

The base portions 36 are both ends for fixing the piezoelectric resonator element 31 to the diaphragm 40. Also, in this embodiment, the base portions 36 include electrodes 39b serving as relays when the resonating arms 34 and 35 receive or output signals from or to the outside.

Extended electrodes 39c to be electrically connected to the above-mentioned electrodes 39b serving as relays are provided on a surface adjacent to a supporting portion 45 to be described later, of the diaphragm 40. The extended electrodes 39c are electrically connected to the above-mentioned terminals provided on the substrate 20 via input/output electrodes 39d.

The frame 32 is a member that makes the internal space S which contains the piezoelectric resonator element 31 together with the recess of the substrate 20 and is a member laminated on and fixed to the peripheral portion 42 of the diaphragm 40. Specifically, there are spaces between the frame 32 and at least the resonating arms 34 and 35. Also, the frame 32 is coupled to the base portions 36 provided at both ends of the piezoelectric resonator element 31 via connecting portions 38 and is formed integrally with the piezoelectric resonator element 31 and connecting portions 38. In this embodiment, the frame 32, connecting portions 38, and piezoelectric resonator element 31 are made of one crystal wafer, for example, using photolithography and etching.

The connecting portions (beams) 38 are thinner than the base portions 36. Specifically, the connecting portions 38 hamper deformation of the resonating arms 34 and 35 after bonding the base portions 36 and the supporting portion 45 of the diaphragm 40 together; therefore, it is preferable that the connecting portions 38 do not exist. For this reason, in this embodiment, the connecting portions 38 are formed as thinned so that the framed resonator 30 and diaphragm 40 can be bonded together in such a manner that the base portions 36 and supporting portion 45 are aligned.

A through hole 38a is provided between the portion formed by each connecting portion 38 and an adjacent base portion 36 and a side extending in the x direction, of the frame 32 in such a manner that the through hole 38 passes through the connecting portion 38 in the thickness direction thereof. The above-mentioned configuration where the connecting portions 38 are thinned and the through holes 38a are made thereon allows the resonating arms 34 and 35 of the piezoelectric resonator element 31 to easily expand or contract in the direction (y axis direction) of arrangement of the pair of base portions 36 when the pressure receiving surface 43 of the diaphragm 40 receives pressure P to be measured from the outside, as shown in FIG. 2. That is, the above-mentioned configuration can prevent the connecting portions 38 from hampering expansion or contraction of the resonating arms 34 and 35 in the y axis direction.

The connecting portions 38 are beams extending from both ends in the width direction (that is, in the x axis direction perpendicular to the y axis direction linking the base portions shown in the drawings), of each base portion 36 along the width direction as separated from each other. These beams intersect the frame in the y axis direction so as not to hamper deformation in the y axis direction (the connecting portions 38 perpendicular to the frame are shown in FIG. 1).

Due to the above-mentioned beam configuration, the configuration (rigidity) of the framed resonator 30 becomes symmetrical with respect to the center line in the y axis direction. Due to the above-mentioned symmetrical configuration, the deformation amounts of the left portion and right portion of the piezoelectric resonator using the center line in the y axis direction as the border become equal to each other. Thus, force transmitted from the diaphragm 40 to the piezoelectric resonator element 31 can be distributed to the two resonating arms 34 and 35 uniformly.

Also, in order to reduce vibration leakage, the connecting portions 38 are preferably formed in positions as far as possible from the resonating arms 34 and 35. As shown, each connecting portion 38 is connected to both ends in the width direction, of the end opposite to the resonating arms 34 and 35, of the adjacent base portion 36.

The excitation electrodes 39a formed on the resonating arms 34 and 35 of the piezoelectric resonator are electrically connected to the terminal electrodes formed on the external frame via the extended electrodes 39c formed on the connecting portions (beams).

The diaphragm 40 is a member that shuts off the internal space S from the outside and transmits the pressure P received from the outside to the piezoelectric resonator element 31. The diaphragm 40 includes the deformable portion 41 formed in the shape of a thin film so as to transmit the minute pressure P, and the peripheral portion 42 surrounding the deformable portion 41. Also, the diaphragm 40 has the supporting portions 45 and thick portions 50 on the sealed main surface (the second main surface) 44 opposite to the pressure receiving surface 43 of the deformable portion 41.

The peripheral portion 42 is formed in such a manner that it is thicker than the thin deformable portion 41. The peripheral portion 42 is laminated on and bonded to the frame 32 of the framed resonator 30, which is laminated on and bonded to the substrate 20.

As for the diaphragm 40, the peripheral portion 42 thereof is bonded and fixed to the end surface 24 adjacent to the opening, of the substrate 20 with the frame 32 of the framed resonator 30 therebetween. For this reason, the diaphragm 40 is made of a material having a thermal expansion coefficient similar to that of the frame 32.

In the diaphragm 40 according to this embodiment, the center C of the sealed main surface 44 is a portion having the largest displacement amount, of the deformable portion 41, as shown in FIG. 3.

The pair of supporting portions 45a and 45b are formed on the sealed main surface 44 with the center C of the main surface 44 interposed between. The supporting portions 45a and 45b serve as pedestals for bonding the base portions 36 of the piezoelectric resonator element 31. By disposing the pressure sensing element 31 supported and fixed by the supporting portions 45a and 45b in such a manner that the pressure sensing element 31 straddles the center C of the sealed main surface 44, the largest stress acts on the resonating arms 34 and 35 serving as pressure sensing portions. Thus, the sensitivity with which a pressure variation is detected is increased.

The thick portions 50 are formed on the area between the pair of supporting portions 45a and 45b when the diaphragm 40 is seen from above and on the area interposed between the peripheral portion 42 of the diaphragm 40 parallel with the direction of arrangement of the supporting portions 45a and 45b and the above-mentioned area between the supporting portions 45a and 45b in such a manner that the thickness of each thick portion 50 is larger than that of the thin deformable portion 41.

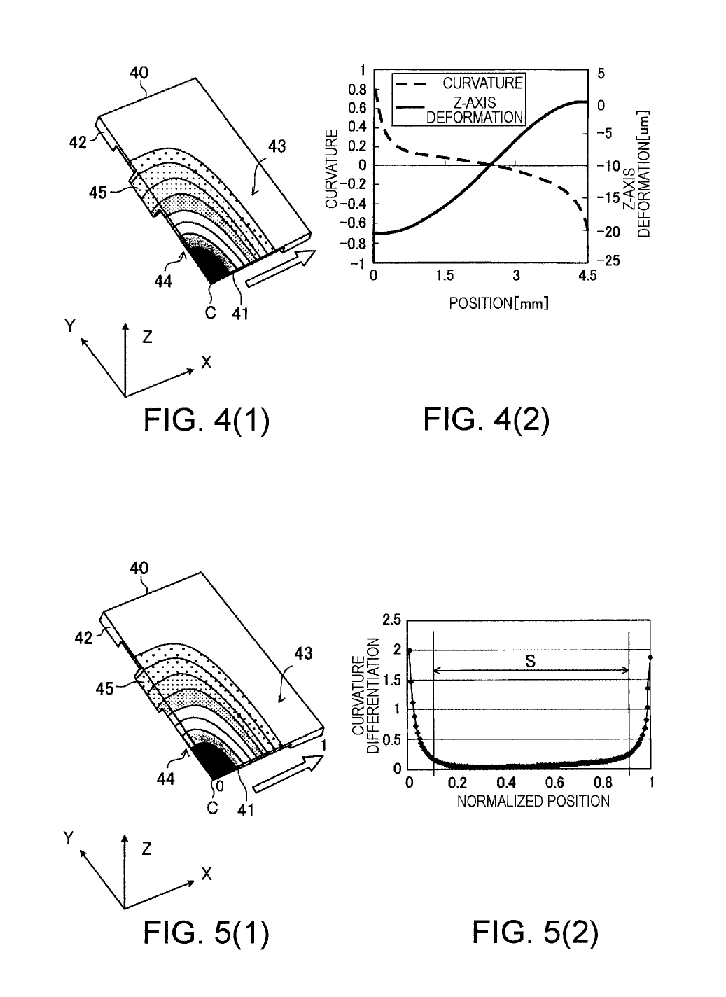

Next, the disposition locations of the thick portions 50 according to this embodiment will be described. FIGS. 4(1) and 4(2) are drawings showing the curvature of deformation of the diaphragm 40 made when the deformable portion 41 thereof becomes deformed. FIG. 4(1) is a partial enlarged perspective view of the diaphragm 40 cut in the direction of a straight line passing through the center C of the pressure receiving surface 43 and the centers of the pair of supporting portions 45 and in the direction of a straight line passing through the center of the pressure receiving surface and extending in perpendicular to the above-mentioned straight line direction. In a graph shown in FIG. 4(2), the lateral axis represents the position on a section from the center C of the pressure receiving surface 43 of the diaphragm to the edge of the deformable portion 41 as shown by an arrow of FIG. 4(1), and the longitudinal axis represents the curvature (broken line) and deformation (solid line) in the z axis direction.

FIGS. 5(1) and 5(2) are drawings showing the change rate of the curvature of deformation of the diaphragm using curvature differentiation. In FIG. 5(2), the lateral axis represents the sectional position assuming that, in a section cut off from the center C of the pressure receiving surface 43 of the diaphragm 40 in the short side direction (arrow), which is the x axis direction, the center C of the diaphragm 40 is zero and the edge of the deformable portion 41 is 1. The longitudinal axis represents curvature differentiation. As shown in FIGS. 4(1) and 4(2), the curvature of the diaphragm 40 abruptly increases at the center C and edge of the deformable portion 41; on the other hand, the curvature reduces in the range between the position approximately 0.5 mm from the center C and the position approximately 0.5 mm to the above-mentioned end, that is, in the range of approximately 0.5 mm to approximately 4.0 mm. Also, as shown in FIGS. 5(1) and 5(2), the curvature differentiation of the diaphragm abruptly increases in the range of approximately 0.05 from the center C of the deformable portion 41 toward the above-mentioned edge and the range of approximately 0.05 from the edge to the center C; on the other hand, the curvature differentiation significantly reduces in the range (range of 0.1 to 0.9) indicated by an arrow S, as in the curvature shown in FIGS. 4(1) and 4(2). Heretofore, the sectional positions in the short side direction, of the diaphragm in FIGS. 4(1) and 4(2), and FIGS. 5(1) and 5(2) have been examined. Likewise, for the sectional positions in the long side direction, of the diaphragm, the curvature and curvature differentiation tend to increase at the center C and edge of the deformable portion. Thus, it is understood that if the thick portions 50 having rigidity are formed in the vicinities of the center C and edge of the deformable portion, which are portions having a large curvature, deformation of the diaphragm 40 is significantly hampered.

For this reason, the thick portions 50 according to this embodiment are provided on areas that do not make contact with any of the supporting portions 45a and 45b on the sealed main surface 44 and the peripheral portion 42; the thick portions 50 are not provided on hatched areas on the sealed main surface 44 of the diaphragm 40 shown in FIG. 3. Specifically, the original thick portion 50 is divided into four parts by making notches 51 on the thick portion 50 along a straight line (first virtual line) L1, which is a straight line passing through the center C of the sealed main surface 44 and the centers of the supporting portions 45a and 45b and a straight line (second virtual line) L2, which is a straight line passing through the center C of the sealed main surface 44 and extending in a direction perpendicular to the first straight line L1. Each notch 51 is formed with a predetermined width symmetrical with respect to the straight line L1 or L2. The notches 51 form a cross.

As seen, the pressure receiver has the thick portions in positions symmetrical with respect to the first virtual line passing through the center of the second main surface (sealed main surface) and extending in the direction of arrangement of the pair of supporting portions and the second virtual line passing through the center and extending in a direction perpendicular to the first virtual line.

Incidentally, there is a rectangular, framed-shaped area that surrounds the peripheral portion 42 on the pressure receiving surface 41 between the supporting portions 45a and 45b of the diaphragm 40 and the thick portions 50 adjacent to the supporting portions 45a and 45b. This hatched area is an area having a large curvature; therefore, no thick portion 50 is provided thereon.

Each thick portion 50 is formed in such a manner that the thickness thereof is larger than that of the thin film-shaped deformable portion 41. Thus, each thick portion 50 has rigidity.

As seen, the thick portions having an effect of restraining vibration of the pressure receiver are formed in positions symmetrical with respect to at least one of the first virtual line passing through the center of the second main surface and extending in the direction of arrangement of the pair of supporting portions and the second virtual line passing through the center and extending in a direction perpendicular to the first virtual line. This restrains Dip, as well as prevents deterioration of the deformation sensitivity of the pressure receiver.

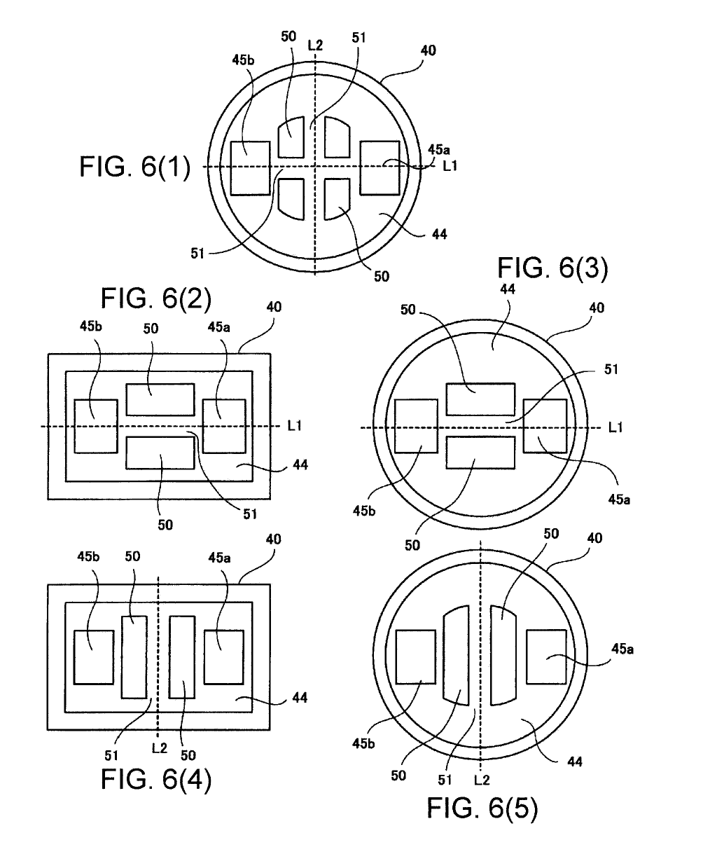

FIGS. 6(1) to 6(5) are drawings showing a modification of the thick portions of the diaphragm for use in the pressure sensor. That is, the diaphragm 40 for use in the pressure sensor according to this embodiment may be configured as follows rather than configured as shown in FIG. 3.

In FIG. 6(1), the external shape of the diaphragm is a circle. As with the diaphragm 40 shown in FIG. 3, the thick portion 50 is divided into four parts by forming the notches 51 in the shape of a cross with a predetermined width symmetrical with respect to the straight line L1 or L2. Thus, an advantage similar to that of the diaphragm shown in FIG. 3 is obtained.

In FIG. 6(2), the external shape of the diaphragm is a rectangle. The thick portion 50 is divided into two parts by forming the notch 51 with a predetermined width symmetrical with respect to the straight line L1.

In FIG. 6(3), the external shape of the diaphragm is a circle. The thick portion 50 is divided into two parts by forming the notch 51 with a predetermined width symmetrical with respect to the straight line L1.

For the diaphragms shown in FIGS. 6(2) and 6(3), the thick portion 50 is divided into two parts using the straight line L1 as the center and therefore the resultant thick portions 50 are symmetrical with respect to the straight line L1. For this reason, the deformation sensitivities of the deformable portions of these diaphragms are slightly lower than those of the thick portions shown in FIG. 3 and FIG. 6(1); however, an effect of restraining Dip of the CI value is obtained.

In FIG. 6(4), the external shape of the diaphragm is a rectangle. The thick portion 50 is divided into two parts by forming the notch 51 with a predetermined width symmetrical with respect to the straight line L2 perpendicular to the straight line L1.

In FIG. 6(5), the external shape of the diaphragm is a circle. The thick portion 50 is divided into two parts by forming the notch 51 with a predetermined width symmetrical with respect to the straight line L2 perpendicular to the straight line L1.

For the diaphragms shown in FIGS. 6(4) and 6(5), the thick portion 50 is divided into two parts using the straight line L2 perpendicular to the straight line 1 as the center and therefore the resultant thick portions 50 are symmetrical with respect to the straight line L2. For this reason, the deformation sensitivities of the deformable portions of these diaphragms are slightly lower than those of the thick portions shown in FIG. 3 and FIG. 6(1); however, an effect of restraining Dip of the CI value is obtained.

Also, for the thick portion formation structures shown in FIGS. 6(2) and 6(3), the area of the pressure receiving portion opposed to the thick portions is smaller than that in the formation structures shown in FIGS. 6(4) and 6(5). Thus, the distances between the thick portions and piezoelectric resonator element are increased. As a result, an advantage that the viscous drag is reduced and the resonance of the pressure sensing element is stabilized is obtained.

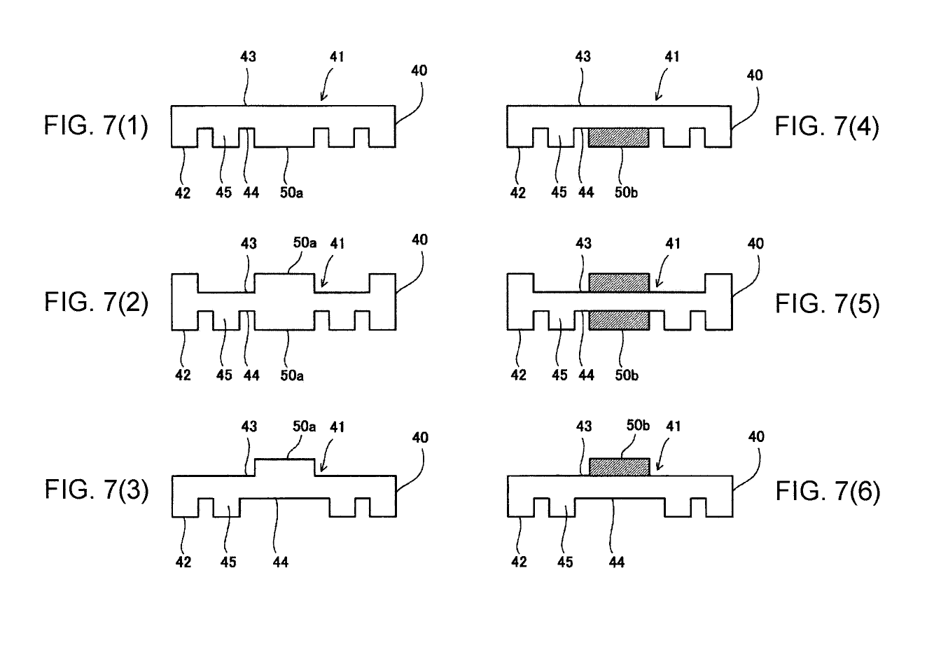

The thick portions 50 according to this embodiment can be manufactured using the following method. FIGS. 7(1) to 7(6) are drawings showing a thick portion. FIGS. 7(1) to 7(3) are sectional views of the diaphragm 40 formed integrally with a thick portion. FIGS. 7(4) to 7(6) are sectional views of the diaphragm 40 formed in such a manner that a thick portion is bonded thereto. FIGS. 7(1) and 7(4) show configurations where a thick portion is formed on the sealed main surface 44 of the deformable portion 41 of the diaphragm 40. FIGS. 7(2) and 7(5) show configurations where thick portions are formed on both surfaces of the deformable portion 41 of the diaphragm 4, that is, on the pressure receiving surface 43 and the sealed main surface 44. FIGS. 7(3) and 7(6) show configurations where a thick portion is formed on the pressure receiving surface 43 of the deformable portion 41 of the diaphragm 40.

A thick portion 50a shown in each of FIGS. 7(1) to 7(3) is formed simultaneously when the diaphragm 40 is manufactured. Specifically, first, the peripheral portion 42, supporting portion 45, and thick portion 50, for example, on a crystal substrate is covered with a mask. Subsequently, etching is performed until the thicknesses of portions that are not covered with the mask, of the diaphragm 40 become thicknesses required by the peripheral portion 42, supporting portion 45, and thick portion 50. Alternatively, after masking the peripheral portion 42, supporting portion 45, and thick portion 50 on the substrate, sandblasting is performed until the thicknesses of portions that are not covered by the mask become thicknesses required by the peripheral portion 42, supporting portion 45, and thick portion 50. By using the above-mentioned methods, the diaphragm manufacturing process and the thick portion manufacturing process can be performed simultaneously. Therefore, the process of manufacturing only a thick portion can be omitted.

On the other hand, a thick portion 50b shown in each of FIGS. 7(4) to 7(6) is preferably made of a material having a thermal expansion coefficient approximately equal to that of the diaphragm. Alternatively, the thick portion 50b may be made of an organic material, such as an epoxy resin, or an inorganic material, such as low-melting-point glass or ceramic. The thick portion 50b made of such a material is bonded to the mounting positions of the diaphragm 40 shown in FIGS. 3 and 6(1) to 6(5) using an adhesive. By using the above-mentioned method, the thickness of the thick portion 50b can be adjusted regardless of what is the thickness of the diaphragm 40. Also, after manufacturing the diaphragm 40, the thick portion 50b can be formed in a downstream process.

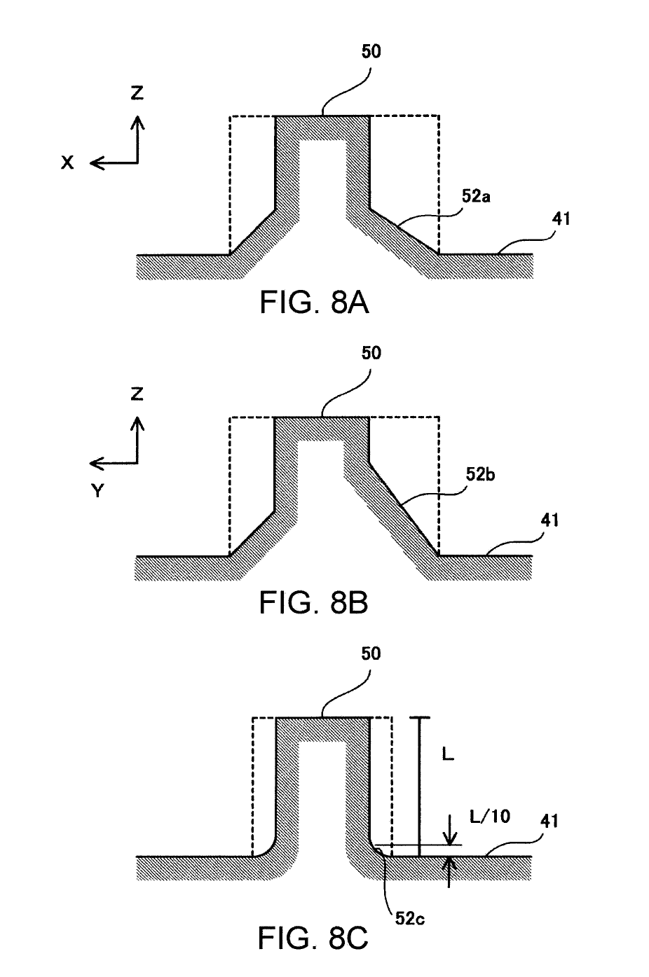

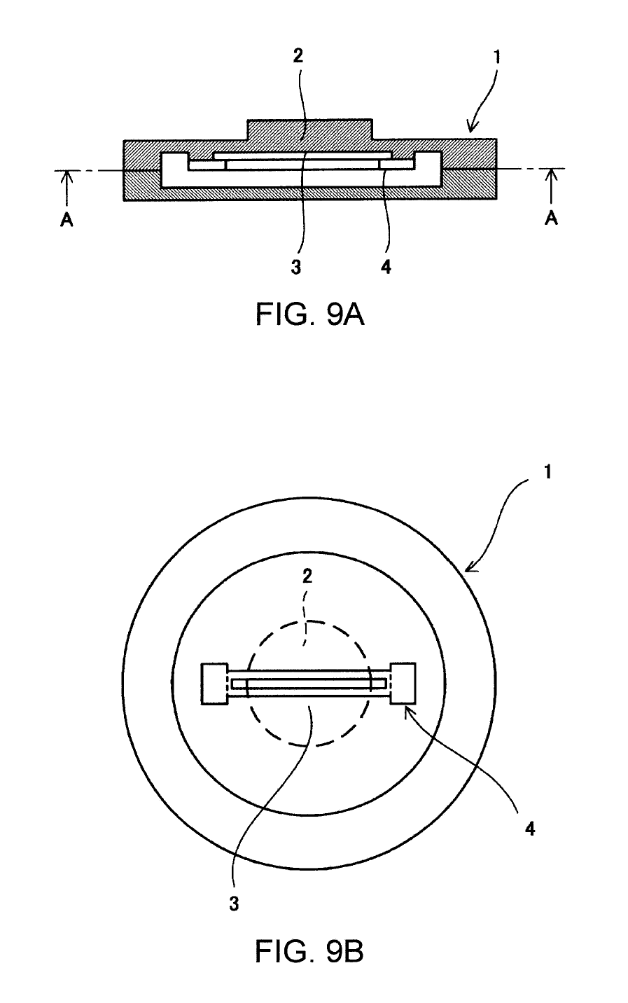

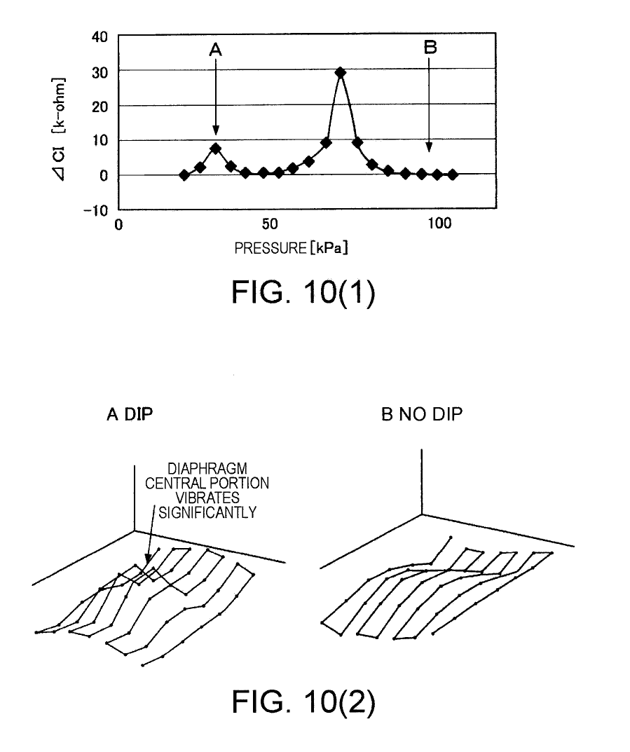

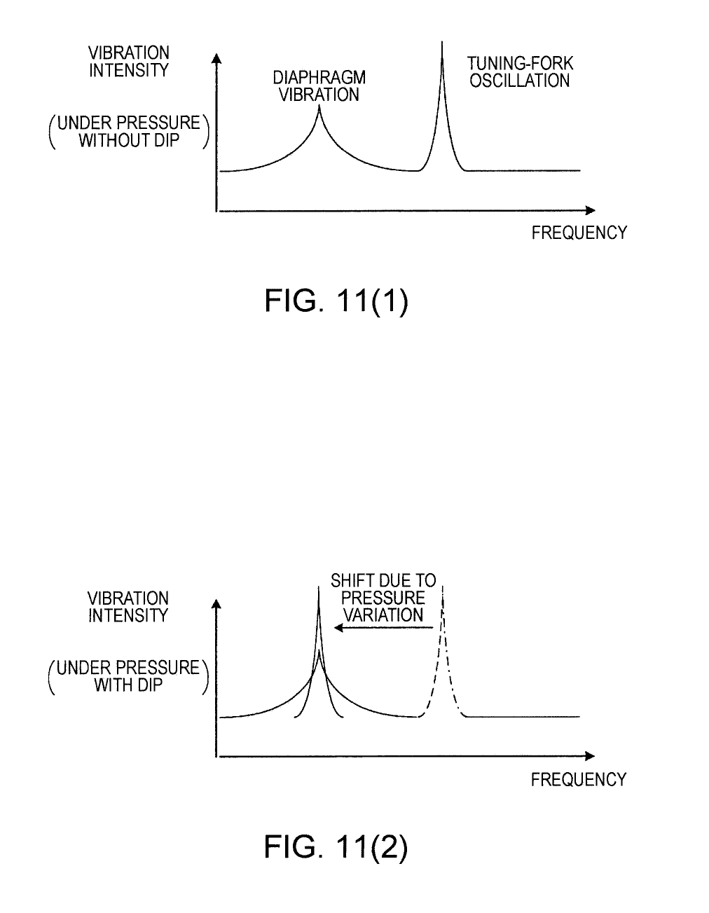

Incidentally, when performing wet etching on a material having an anisotropic crystal structure, such as a quartz crystal substrate, the sectional shape of the material varies depending on the position where a recess or protrusion is provided and thus the volume per unit length of the protrusion varies. FIGS. 8A to 8C are partial enlarged sectional views of a thick portion. FIGS. 8A and B are partial sectional views of a thick portion manufactured using etching. FIG. 8C is a partial sectional view of a thick portion manufactured using sandblasting. As shown in the drawings, the diaphragm uses z-plate quartz crystal cut out perpendicularly to the z axis. The thick portion 50 shown in FIG. 8A is formed in a direction perpendicular to an xz plane formed by the x axis and z axis of the crystal axes of quartz crystal. The thick portion 50 shown in FIG. 8B is formed in a direction perpendicular to a yz plane formed by the y axis and z axis of the crystal axes of quartz crystal. As shown in FIGS. 8A and 8B, depending on the position where the thick portion 50 is provided, the tilt angles formed by the deformable portion 41 of the diaphragm and skirts 52a and 52b of the thick portion 50 vary. Therefore, the sectional areas are different from one another. The above-mentioned portion of the diaphragm thicker than the thin film-shaped deformable portion 41 has a lower sensitivity. Therefore, in this embodiment, the thicker portion, that is, the thicker portion including the skirts 52 is referred to as the “thick portion 50.” In the thick portion 50 shown in FIG. 8C and manufactured using sandblasting, a skirt 52c is gently tapered, that is, rounded off. In such a case, if the height of the top of the thick portion 50 protruding from the deformable portion 41 is represented by L, the portion between L and L/10 is defined as the thick portion 50. The pressure sensor 10 according to this embodiment has a three-tier structure where the frame 32 of the framed resonator 30 is interposed between the substrate 20 and diaphragm 40 and these elements are bonded together using a bonding member, such as an adhesive. Specifically, the diaphragm 40, framed resonator 30, and substrate 20 of the pressure sensor 10 are made of a material in accordance with the cut angle of the piezoelectric resonator element, for example, a material that is z-plate quartz crystal cut out perpendicularly to the z axis and has an approximately equal thermal expansion coefficient α. Then, as shown in FIG. 2, an inorganic adhesive is used as an adhesive member 60 between the diaphragm 40 and framed resonator 30 and between the framed resonator 30 and substrate 20. After the inorganic adhesive is cured, it obtains predetermined rigidity. Thus, a favorable CI value is obtained. Also, reductions in stress on the bonding portions are reduced and aged deterioration is reduced.

As the adhesive member 60, an adhesive having a thermal expansion coefficient a equal to that of the material of the diaphragm or the like may be used. Thus, favorable temperature characteristics can be obtained.

Use of the pressure sensor and pressure receiver according to this embodiment restrains Dip, as well as prevents deterioration of the deformation sensitivity of the diaphragm.

The entire disclosure of Japanese Patent Application No. 2009-177797, filed Jul. 30, 2009 and Japanese Patent Application No. 2008-267501, filed Oct. 16, 2008 is expressly incorporated by reference herein.

What is claimed is:

1. A pressure sensor, comprising:
a pressure sensing element including:
a pressure sensing portion; and
a pair of base portions connected to both ends of the pressure sensing portion; and
a pressure receiver having a first main surface that is a pressure receiving surface and having a second main surface that is a back side of the pressure receiving surface, the pressure receiver including a pair of supporting portions provided on the second main surface, the pair of supporting portions covering one main surface of the pressure sensing element and supporting the pair of base portions of the pressure sensing element, wherein
the pressure receiver has a thick portion in a position symmetrical with respect to at least one of a first virtual line passing through a center of the second main surface and extending in a direction of an arrangement of the pair of supporting portions and a second virtual line passing through the center and extending in a direction perpendicular to the first virtual line.

2. The pressure sensor according to claim 1, wherein
the thick portion is formed on and integrated with at least one of the first main surface and the second main surface of the pressure receiver.

3. The pressure sensor according to claim 1, wherein
the thick portion is formed and bonded on at least one of the first main surface and the second main surface of the pressure receiver.

4. A pressure receiver, comprising:
a first main surface that is a pressure receiving surface;
a second main surface that is a back side of the pressure receiving surface;
a pair of supporting portions that are provided on the second main surface and support a pair of base portions connected to both ends of a pressure sensing element, wherein
the pressure receiver has a thick portion in a position symmetrical with respect to at least one of a first virtual line passing through a center of the second main surface and extending in a direction of an arrangement of the pair of supporting portions and a second virtual line passing through the center and extending in a direction perpendicular to the first virtual line.
